(19) United States
(12) Patent Application Publication
(10) Pub. No.: US 2008/0027984 A1
(43) Pub. Date: Jan. 31, 2008

(54) METHOD AND SYSTEM FOR MULTI-DIMENSIONAL ACTION CAPTURE

(75) Inventors: JORGE L. PERDOMO, BOCA RATON, FL (US); VON A. MOCK, BOYNTON BEACH, FL (US); CHARLES P. SCHULTZ, NORTH MIAMI BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/461,142

(22) Filed: Jul. 31, 2006

(51) Int. Cl. G06F 17/00

(52) U.S. Cl. 707/104.1

(57) ABSTRACT

A system (100) and method (300) is provided for multi-dimensional action capture. The method can include creating a multimedia message (310), associating a sensory action with a multimedia message (320), and assigning an emotional component to the multimedia message based on the sensory action (330). The multimedia message can include at least one of text, audio, or visual element that is modified based on the emotional component to express a user's emotion. In one arrangement, the method of multi-dimensional action capture can be applied to visually render an avatar.

### FIELD OF THE INVENTION

The present invention relates to sensing devices, and more particularly, to methods for determining emotion through sensing.

### BACKGROUND

The use of portable electronic devices and mobile communication devices has increased dramatically in recent years. Mobile devices are capable of establishing communication with other communication devices over landline networks, cellular networks, and, recently, wide local area networks (WLANs). Mobile devices are capable of providing access to Internet services which are bringing people closer together in a world of information. Mobile devices operating over a telecommunications infrastructure are capable of providing various forms of multimedia. People are able to collaborate on projects, discuss ideas, interact with one another on-line, all while communicating via text, audio, and video. Such mobile communication multimedia devices are helping people succeed in business and in their personal endeavors.

As technologies converge and become rapidly available to the public, people become more adept at working with the new technologies to facilitate their communication and conversation. People can adapt to new technologies and learn how to express themselves through applied use of the technology. For example, people have created text slang for text messaging applications, which can consist of short letters for representing words. This can save time and allow people to type more efficiently. As another example, text messaging applications can include symbols within the text, such as a smiley or frown face, for conveying an emotion. Cell-phones equipped with cameras can also capture a person's expression during conversation. However, there are certain natural elements such as movement or anxiety to a social conversation that cannot be adequately captured via text, audio, or video. In addition, conveying this information within a group environment, such as a conference situation or a public exposition, can be a challenging task. Accordingly, natural communication between people can be limited to the form of information technically available to them. A need therefore exists, for providing emotional content to a conversation based on social behavior that complements text, audio, and video.

### SUMMARY

Embodiments of the invention are directed to a method and system for multi-dimensional action capture. The method can include creating a multimedia message, associating a sensory action with a multimedia message, and assigning an emotional component to the multimedia message based on the sensory action. The multimedia message can include at least one of text, audio, or visual element that is modified based on the emotional component to express a user's emotion. This can include network or messaging of presence indication such as an availability, do not disturb, etc. In one arrangement, the method of multi-dimensional action capture can be applied during the composition of a multimedia message to convey an emotion. For example, the emotional component can instruct a change of text, such as the color or font size, a change in audio, such as an alert or equalization, or a change in visual information, such as a change in light color or pattern to express the user's emotion. The method and system for multi-dimensional capture can be included on a mobile device, a computer, a laptop, or any other suitable communication system.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a diagram of a mobile communication environment;

FIG. 2 is diagram of a mobile device for multi-action capture in accordance with the embodiments of the invention;

FIG. 3 is a method for multi-dimensional action capture in accordance with the embodiments of the invention;

FIG. 4 is diagram of a processor of the mobile device in FIG. 2 for assessing sensory actions in accordance with the embodiments of the invention;

FIG. 5 is a diagram of the mobile device of FIG. 2 equipped with one or more sensory elements of FIG. 4 in accordance with the embodiments of the invention;

FIG. 6 is a schematic of a sensory element in accordance with the embodiments of the invention;

FIG. 7 is a decision chart for classifying an emotion based on a sensory action in accordance with the embodiments of the invention;

FIG. 8 is a method for assessing an emotion and assigning a mood rating in accordance with the embodiments of the invention; and

FIG. 8 is another method for assessing an emotion and assigning a mood rating in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” or “processor” can be defined as any number of suitable processors, controllers, units, or the like that are capable of carrying out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a midlet, a servlet, a source code, an object code, a shared library/dynamic load library and/or other sequence of instructions designed for execution on a computer system. The term “sensory action” can be a physical response, a physical stimulation, or a physical action applied to a device. An “emotional component” can be defined as an audio attribute or visual attribute such as text type, font size or color, audio volume, audio equalization, visual rendering, visual aspect associated with a sensory action. A “multimedia message” can be defined as a data, a packet, an audio response, a visual response, that can be communicated between devices, systems, or people in real-time or non-real-time. The term “real-time” can be defined as occurring coincident at the moment with minimal delay such that a real-time response is perceived at the moment. The term “non-real-time” can be defined as occurring at a time later that a response is provided. A “sensory element” can be a transducer for converting a physical action to an electronic signal.

Embodiments of the invention provide a system and method for multi-dimensional action capture. Multi-dimensional action capture includes identifying an emotion during a communication and associating the emotion with a means of the communication. Multi-dimensional action capture applies an emotional aspect to text, audio, and visual communication. For example, multi-dimensional action capture can sense a physical response during a communication, measure an intensity, duration, and location of the physical response, classify the measurements as belonging to an emotional category, and include an emotional component representing the emotional category within a message for conveying the emotion. The message and the emotional component can be decoded and presented to a user.

In practice, a multimedia message can be created that is associated with a sensory action, for example, a physical response. An emotional component can be assigned to the multimedia message based on the sensory action. The multimedia message can include at least one of text, audio, or visual element that is modified based on the emotional component. For example, the emotional component provides instructions for adjusting an attribute of the text, such as font size or color, for conveying an emotion associated with the text. In one aspect, a level of the emotion can be determined by assessing a strength of a physical response. For example, a sensor element can measure an intensity, speed, and pressure of the response during a communication for classifying an emotion. The multimedia message can be conveyed in real-time such that the feedback provided by the physical response is imparted to the performance at the moment the feedback is provided. Understandably, slight delay may exist, though the delay will not detrimentally delay the audience feedback. For example, audience members can squeeze a mobile device for adjusting an audio equalization of a live performance in real-time.

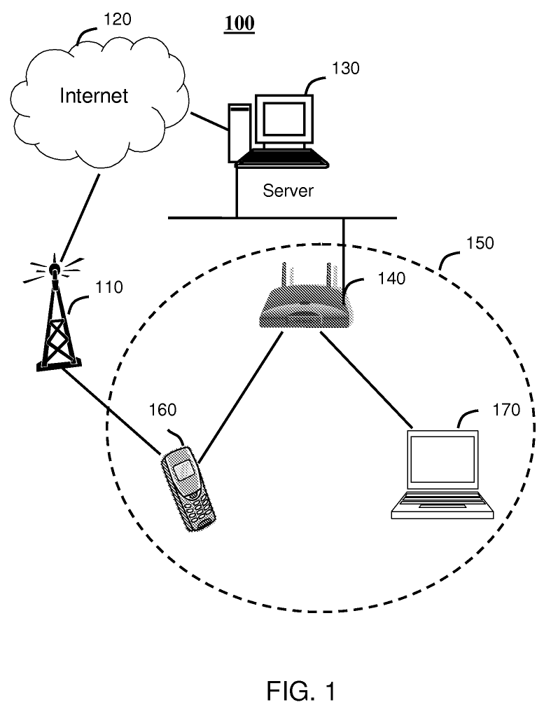

Referring to FIG. 1, a mobile communication environment 100 is shown. The mobile communication environment 100 can provide wireless connectivity over a radio frequency (RF) communication network or a Wireless Local Area Network (WLAN). Communication within the network 100 can be established using a wireless, copper wire, and/or fiber optic connection using any suitable protocol (e.g., TCP/IP, HTTP, etc.). In one arrangement, a mobile device 160 can communicate with a base receiver 110 using a standard communication protocol such as CDMA, GSM, or iDEN. The base receiver 110, in turn, can connect the mobile device 160 to the Internet 120 over a packet switched link. The Internet 120 can support application services and service layers for providing media or content to the mobile device 160. The mobile device 160 can also connect to other communication devices through the Internet 120 using a wireless communication channel. The mobile device 160 can establish connections with a server 130 on the network and with other mobile devices 170 for exchanging data and information. The server can host application services directly, or over the Internet 120.

The mobile device 160 can also connect to the Internet 120 over a WLAN. Wireless Local Access Networks (WLANs) provide wireless access to the mobile communication environment 100 within a local geographical area. WLANs can also complement loading on a cellular system, so as to increase capacity. WLANs are typically composed of a cluster of Access Points (APs) 140 also known as base stations. The mobile communication device 160 can communicate with other WLAN stations such as the laptop 170 within the base station area 150. In typical WLAN implementations, the physical layer uses a variety of technologies such as 802.11b or 802.11g WLAN technologies. The physical layer may use infrared, frequency hopping spread spectrum in the 2.4 GHz Band, or direct sequence spread spectrum in the 2.4 GHz Band. The mobile device 160 can send and receive data to the server 130 or other remote servers on the mobile communication environment 100.

In one example, the mobile device 160 can send and receive multimedia data to and from the laptop 170 or other devices or systems over the WLAN connection or the RF connection. As another example, the mobile device can communicate directly with other mobile devices over non-network assisted communications, for example, Mototalk. The multimedia data can include an emotional component for conveying a user's emotion. In one example, a user of the mobile device 160 can conduct a voice call to the laptop 170, or other mobile device within the mobile communication environment 100. During the voice call the user can squeeze the mobile device in a soft or hard manner for conveying one or more emotions during the voice call. The intensity of the squeeze can be conveyed to a device operated by another user and presented through a mechanical effect, such as a soft or hard vibration, or through an audio effect, such as a decrease or increase in volume. Accordingly, the other user may consider the vibration effect or the change in volume with an emotion of the user. The emotional component can be included in a data packet that can be transmitted to and from the mobile device 160 to provide an emotional aspect of the communication. A visual aspect can also be changed such as an icon, a color, or an image which may be present in a message, or on a display.

The mobile device 160 can be a cell-phone, a personal digital assistant, a portable music player, a handheld gaming device, or any other suitable communication device. The mobile device 160 and the laptop 170 can be equipped with a transmitter and receiver for communicating with the AP 140 according to the appropriate wireless communication standard. In one embodiment of the present invention, the wireless station 160 is equipped with an IEEE 802.11 compliant wireless medium access control (MAC) chipset for communicating with the AP 140. IEEE 802.11 specifies a wireless local area network (WLAN) standard developed by the Institute of Electrical and Electronic Engineering (IEEE) committee. The standard does not generally specify technology or implementation but provides specifications for the physical (PHY) layer and Media Access Control (MAC) layer. The standard allows for manufacturers of WLAN radio equipment to build interoperable network equipment.

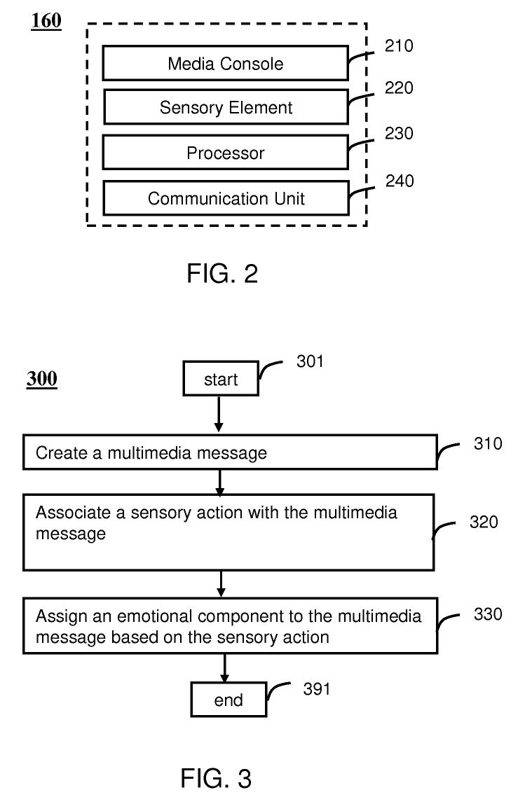

Referring to FIG. 2, a diagram of the mobile device 160 for multi-action capture is shown. Notably, the mobile device 160 can identify an emotional aspect of a communication and convey an emotional component with a means of the communication. The mobile device 160 can include a media console 210 for creating a multimedia message, at least one sensory element 220 cooperatively coupled to the communication unit for capturing a sensory action, and a processor 230 communicatively coupled to the at least one sensory element for assessing the sensory action and assigning an emotional component to the multimedia message based on the sensory action. The mobile device 160 may include a communication unit 240 for sending or receiving multimedia messages having an embedded emotional component.

The media console 210 can create a multimedia message such as a text message, a voice note, a voice recording, a video clip, and any combination thereof presented. In another example, an icon or an avatar can be changed. An avatar is a virtual rendering of the user's own choosing that represents the user in a virtual environment such as a game or a chat room. The media console 210 can transmit or receive multimedia messages via the communications unit 240 and render the media according to content descriptions which can include an embedded emotional component. For example, the media console 210 can decode an emotional component associated with a multimedia message and adjust one or more attributes of the message based on the emotional component. For example, the emotional component can instruct certain portions of text to be highlighted with a certain color, certain portions of the text to have a larger font size, or to include certain symbols with the text based on one or more sensory actions identified by the sensory elements 220.

Referring to FIG. 3, a method 300 for multi-dimensional action capture is shown. The method 300 can be practiced with more or less than the number of steps shown. To describe the method 300, reference will be made to FIG. 2, although it is understood that the method 300 can be implemented in any other suitable device or system using other suitable components. Moreover, the method 300 is not limited to the order in which the steps are listed in the method 300 In addition, the method 300 can contain a greater or a fewer number of steps than those shown in FIG. 3.

At step 301, the method can begin. At step 310, a multimedia message can be created. For example, referring back to FIG. 2, the media console 210 can create a text, audio, or visual message. In one arrangement, a user of the mobile device 160 can create the multimedia message to be transmitted to one or more other users. Alternatively, a multimedia message may be received which the user can respond to by including an emotional component. The emotional component may be an image icon or a sound clip to convey an emotion of a user response. For instance, the image icon can be a picture of a happy event or a sad event. Notably, the emotional component is assigned to the multimedia message based on a sensory action.

At step 320, a sensory action can be associated with the multimedia message. For example, referring back to FIG. 2, the media console 210 coupled with the sensory element 220 and processor 230 extend conventional one-dimensional messaging to a multi-dimensional message by including sensory aspects associated with the communication dialogue. In particular, the processor 230 can evaluate one or more sensory actions at one or more sensory elements 220. A sensory action can be a depressing action, a squeezing action, a sliding action, or a movement on one of the sensory elements 220. In another aspect, the processor 230 can identify a location and an intensity of the sensory action. Depending on the location of the one or more sensory elements 220, the processor 230 can associate a sensory action with a position.

For example, a user may express one or many different emotions based on an assignment of the one or more sensory elements 220. For example, a first sensory element may signify a happy tone, whereas a second sensory element may signify a sad tone. The user can depress the sensory elements in accordance with an emotion during a composition of a multimedia message or a reply to a message. In another example, the user may squeeze the device 160 during composition of a multimedia message to inject an emotional aspect of the message in accordance with one or more sensory actions. The user may squeeze certain portions of the phone harder or softer than other portions for changing an equalization of the audio composition. Notably, various sensors impart differing changes to the audio composition. In another example, the user may receive a multimedia message and comment on the message by squeezing the phone or imparting a physical activity to the phone that can be detected by the sensory elements 220. For example, a user can orient the phone in a certain position, shake the phone up and down, joggle the phone left and right to cause the emotional indicator to be added to the message. An intensity, duration, and location of the squeezing can be assessed for assigning a corresponding emotional component. The processor 230 can also evaluate an intensity of the sensory action such as soft, medium, or hard physical action for respectively assigning one of a low, medium, or high priority to the intensity.

In one aspect, a multimedia message can be created that captures the emotional aspects of the hand movement. For example, one or more sensory elements 220 present on the cell phone can capture physical movement of the cell phone or physical actions applied to the phone. In another arrangement, the user can squeeze the cell phone for translating the hand movement to physical gestures. The squeeze allows a user transmit an intensity grade to their message without needing to type additional descriptive adjectives. The intensity, duration, and speed of the sensory actions associated with the squeeze can be classified into an emotional category. For example, a hard squeeze can signify a harsh tone, whereas a soft can signify a passive tone. The emotional component can be communicated to a second user through the multimedia message. For example, upon receiving the multimedia message, the mobile device 160 can vibrate in accordance with the intensity, duration, and speed of the emotional component. Alternatively, an audio effect or video effect can be generated to convey the emotion.

At step 330, an emotional component can be assigned to the multimedia message based on the sensory action. For example, when the user squeezes the mobile device 160, an emotional component can be assigned to the multimedia message. For example, a lighting sequence or an auditory effect can be adjusted during playing of the multimedia message. For example, during text messaging, an emotional component can be conveyed by changing the color of the text in accordance with a mood of the user. This does not require additional text such as adjectives or text phrases to describe the user's emotion. Accordingly, the emotional component can enhance the user experience without overburdening the user during interpretation of the original communication media. The emotional component provides a multi-dimensional aspect to complement an expressive aspect of the communication dialogue that spans more than one dimension.

As another example, the emotional component can include a visual element to enhance the communication dialogue experience. Consider two people that are physically separated and speaking to one another on cell phones that cannot see what the other user is doing when they are speaking. Hand movement and gesture can be beneficial for conveying expressions and mood. Certain cultures use their hands expressively during conversation which cannot be captured by a standard cell phone. Even a cell phone equipped with video may not have a sufficiently wide camera lens to capture the hand gestures. The hand gestures can be an integral element of the conversation which convey emotion and engage the listening party. The processor 230 can determine a movement associated with the motion of the device 160 during hand movement and convey the movement as an emotional component to be rendered on a receiving the device. The receiving device can adjust a lighting effect, and auditory effect, or a mechanical effect based on the movement. The movement may be intentional or unintentional on the part of the user.

In practice, the media console 210 (See FIG. 2) can append descriptor information for generating emotional content associated with the multimedia message. Descriptor information can provide instructions for adjusting one or more attributes of a multimedia message. For example, the emotional component can be a text font, a text color, a text size, an audio volume, an audio equalization, a video resolution, a video intensity, a video hue, a device illumination, a device alert, a device vibration, a sound effect, a mechanical effect, or a lighting effect. The emotional component can be a C object, a Java object, or a Voice XML component, or any other suitable object for conveying data. The emotional component can associate audio effects with a voice, lighting effects with a voice mail message, or change the color of text during a rendering of the multimedia message, but is not herein limited to these. As another example, the user can convey emotion during a voice note or recording which can be manifest during playback (e.g., volume) of transcription (e.g., bold font). Notably, multimedia messages can be transmitted via the communication unit 240 to other multimedia equipped devices capable of rendering the emotional component with the message.

At step 391, the method can end. Embodiments of the invention are not limited to messaging applications, and the method 300 can be practiced during real-time communication; that is, during an active voice call or media session. For example, the emotional components can be activated during the voice call to emphasize emotional aspects of the user's conversation captured during the communication dialogue.

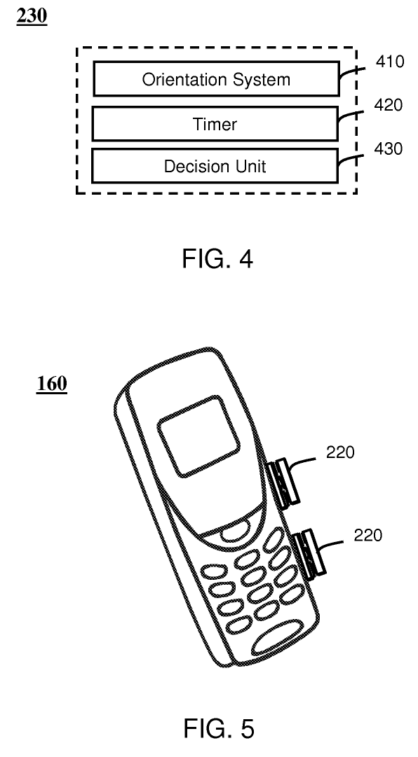

Referring to FIG. 4, a diagram of the processor 230 of FIG. 2 is shown. In particular the diagram reveals components associated with interpreting sensory actions. The processor 230 includes an orientation system 410 for determining an orientation of the mobile device 160, a timer 420 for determining an amount of time the mobile device 160 is in an orientation, and a decision unit 430 for evaluating one or more sensory actions captured by the one or more sensory elements 220. In particular, the components 410-430 of the processor 230 are employed for assessing sensory actions and classifying physical activity associated with the sensory action as belonging to one or more emotional categories. A sensory action can be a depressing of a sensory element 220 which can include an intensity, speed, location, and duration of the depressing. For example, the sensory elements 220 can identify one or more sensory actions, such as a rapid pressing or slow pressing, associated with the mobile device 160. The orientation system 410 can associate the sensory action with an orientation of the device 160 and an amount of time the device is in the orientation. The decision unit 430 can classify sensory actions into one or more emotional categories such as a mood for sadness, anger, contentment, passivity, or the like.

Referring to FIG. 5, a diagram of the mobile device 160 of FIG. 2 equipped with one or more sensory elements 220 of FIG. 2 is shown. The sensory elements 220 can be positioned exterior to the phone at locations corresponding to positions where a user may grip the phone during use. In particular, the mobile device 160 can sense hand position and movement as well as an orientation of the mobile device 160. Briefly referring back to FIG. 4, the orientation system 410 can determine an orientation of the device for associating a sensory event with the orientation. For example, when the user is holding the mobile device at their ear, an inclination angle and yaw of the device can be associated with the position of the device at the ear. When the user is holding the mobile device in front of their face, for example during dispatch communication, an inclination angle and yaw of the device can be associated with the position of the device when held. During this orientation, the user may squeeze the mobile device 160 or slide the hand around on the mobile device 160 at a location of the sensory elements 220 to convey an emotion.

The emotional component created can be dependent of the orientation. For example, the user may squeeze the mobile device to signal an action such as a confirmation, acknowledge a response, generate attention, to be associated with a multimedia message. The decision unit 430 (See FIG. 4) can evaluate the action with regard to the orientation. For example, if the user has fallen down and is unable to hold the mobile device in an upright position, the user can squeeze the phone to signal an alert. In a non-upright position, the squeezing action can signify a response that is different that when the mobile device 160 is in an up-right position. For example, the user can employ the same squeezing behavior when the phone is in an upright position to signal an OK, in contrast to an alert. Notably, the decision unit 430 can identify the orientation for associating the sensory action with the multimedia message. The decision unit 430 can also assess an intensity of the sensory action for providing an emotional aspect. For example, a hard squeeze when the phone is in a non-upright position can signal an “emergency” alert, whereas a soft squeeze in a non-upright position can signal a “non-emergency” alert. Alternatively, a hard squeeze in an upright position can signify a definite “yes, I'm OK”, whereas a soft squeeze in an upright position can signify a “I think I'm OK.”

In another example, the sensory elements 220 may be associated with specific functionality. For example, one or more of the sensory elements 220 may be associated with an equalization of high-band, mid-band, and low-band frequencies. The user may adjust an audio equalization based on a location of an intensity of the sensory action. For instance, during composition of a multimedia message which is generating voice and music, the user may depress the various sensory elements 220 to adjust an equalization of the voice and music during a composition. Understandably, the sensory elements 220 allow the user to selectively equalize the audio based in an emotional sense. That is, the user can incorporate an emotional aspect to the multimedia message by adjusting the equalization through physical touch.

In another aspect the user can perform multiple squeezes of the mobile device 160 for signaling various commands. Understandably, the user can create a database of codes for associating various sensory actions to convey various actions or emotions. For example, if a menu list is presented on the mobile device 160 with one or more options to choose from, the user can associate a single squeeze with selection of the first item, a second squeeze for selection of the second item, or a hold and release squeeze for scrolling through the menu and selecting a list option. Alternatively, the user may receive a survey for a personal opinion on a subject matter. The user can emphasize responses to the survey through sensory activity picked up by the sensory elements. Embodiments of the invention are not limited to these arrangements and one skilled in the art can appreciate the various configurations available to the user based on the type of sensory actions.

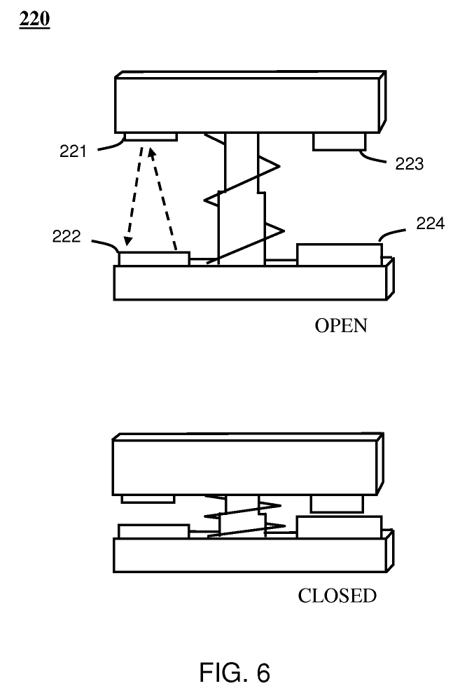

Referring to FIG. 6, a schematic of a sensory element 220 is shown. The sensory element 220 may be a pressure sensitive element, micro-sensor, MEMS sensor, biometric sensor, touch-tactile sensor, traction field sensor, optical sensor, haptic device, capacitive touch sensor, and the like. In the configuration shown, the sensory element is a button having a top portion and a bottom portion separated by a spring mechanism. In an open state, the top portion and the bottom portion are separated. In a closed state the top portion and the bottom portion are united. The sensory elements 230 can monitor human activities during composition of electronic documents, such as email, text messaging, music composition, or other electronic documents. For example, a user may type a message and enter a firm exclamation mark to demarcate a point of emphasis. Accordingly, the decision unit 430 (See FIG. 4) can increase the font size or boldness of the exclamation mark based on the ferocity of the key press action.

The sensory element 220 may contain a sensory detector for measuring an intensity of a sensory action, such as a depressing action, a duration of the sensory action, a speed of the sensory action, and a pressure of the sensory action. For example, the sensory detector may include an infrared light (IR) source for evaluating the intensity, duration, and speed of the sensory action. The IR source may include a transmit element 222 that also serves as a receiver, and a reflection element 221. The transmit element 222 can emit a pulse of light that reflects off the reflective element 221 and returns to the transmit element. A duration of time the light travels between the roundtrip path can be measured to determine a distance. Accordingly, a speed of the top portion during a closing action can be measured. The sensory element 220 may also contain a pressure sensor that can measure the force of a closing action. For example, a top pressure sensory 223 can couple to a bottom pressure sensor 224 when the device is in a closed configuration. The pressure sensory can evaluate the firmness of the depressing action. Understandably, the sensory element 220 may include more or less than the number of components shown for measuring an intensity, speed, duration, and pressure of a sensory action. Embodiments of the invention are not herein limited to the arrangements or components shown, and various configurations are herein contemplated though not shown.

The sensor elements 220 can be installed inside a keyboard or a phone keypad for monitoring key-stroke pressure and key depression speed during typing. The key pressure can be measured by the pressure sensor 224 at the bottom of the key stroke directly under the key pad. The pressure sensor 224 can vary the current flowing through its sensor depending on the pressure that is applied during typing. This current can be sent to an analog-to-digital circuit and read by software as increasing or decreasing the applied pressure.

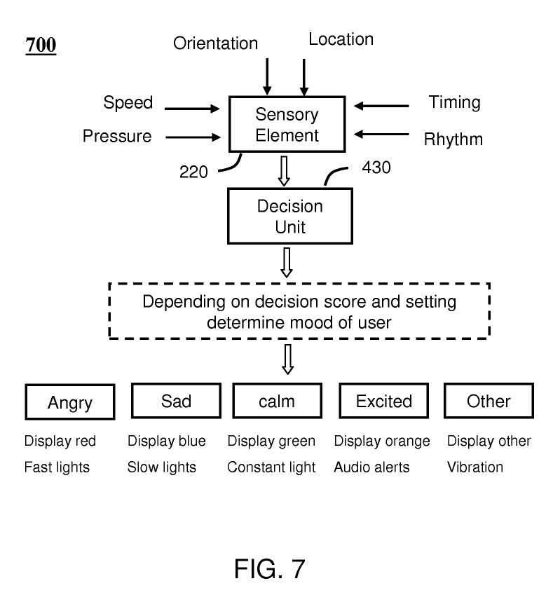

Referring to FIG. 7, a decision chart 700 for classifying an emotion based on a sensory action is shown. The decision chart 700 reveals the sensory inputs the decision unit 430 takes into consideration in classifying an emotion. For example, the decision unit 430 can assess a speed of a sensory action, a pressure of a sensory action, a timing of a sensory action, and a rhythm of a sensory action. The decision unit 430 can also assess an orientation of the device and a location of the sensory action in evaluating an emotion. As was described with reference to FIG. 6, a sensory action is a physical action applied to one or more of the sensory elements 220 on the mobile device 160. The decision unit 430 classifies the physical actions into the one or more emotional categories for creating the emotional component. Based on a decision score, the decision unit 430 can determine a mood of a user and create an emotional component based on the mood. For example, the mood of the user may be deemed angry, sad, calm, or excited based on the sensory actions, though is not limited to these based on a measure of the physical actions. Accordingly, an emotional component can be created which provides instructions for changing a text, audio, or visual behavior. For example, the emotional component can describe changes to the background color of text, a font size, a font color, an audio effect such as a volume change, a lighting effect such as a change in color or pattern.

As a previously recited example, the user may squeeze the phone hard during a voice conversation which can be classified as a tone of anger. Alternatively, the user can rapidly squeeze the phone indicating a tone of excitation, or point of emphasis. Further, the user may sustain a squeeze for emphasizing a passive or calm state. Understandably, various detection criteria can be employed for assessing the physical actions and identifying a corresponding emotional category. Notably, the decision unit 430 assigns an emotional category to a message for complementing the manner in which the message is presented.

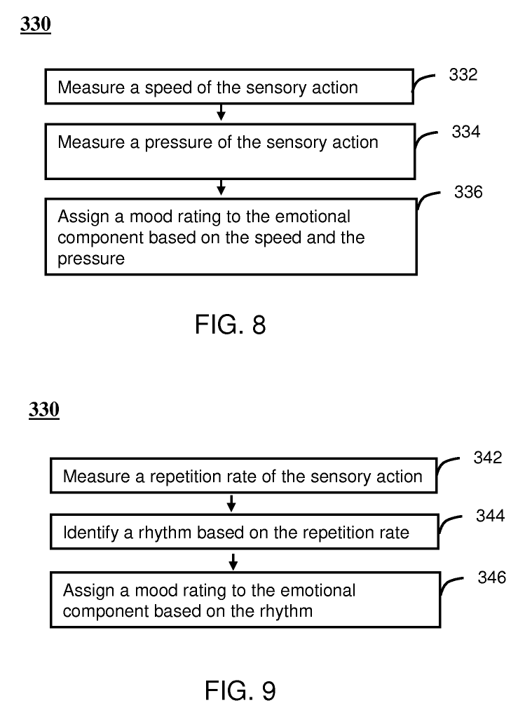

Referring to FIG. 8, one method 330 for assessing an emotion and assigning a mood rating is shown. The decision unit 430 can employ the method 330 for creating the emotional component as described in FIG. 7. The method 330 corresponds to the method step 330 of FIG. 3 for assigning an emotional component to the multimedia message based on the sensory action. The method 330 can include measuring a speed of the sensory action (332), measuring a pressure of the sensory action (334), and assigning a mood rating to the emotional component based on the speed and the pressure (336).

Referring to FIG. 9, another method for assessing an emotion and assigning a mood rating is shown. The decision unit 430 can also employ the method 330 for creating the emotional component as described in FIG. 7. The method 330 also corresponds to the method step 330 of FIG. 3 for assigning an emotional component to the multimedia message based on the sensory action. The method can include measuring a repetition rate of the sensory action (342), identifying a rhythm based on the repetition rate (344), and assigning a mood rating to the emotional component based on the speed and the pressure (346).

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for multi-dimensional action capture, comprising:
creating a multimedia message;
associating a sensory action with said multimedia message; and
assigning an emotional component to the multimedia message based on the sensory action,
wherein the multimedia message includes at least one of text, audio, or visual element that is modified based on the emotional component.

2. The method of claim 1, wherein the emotional component is one of an avatar, a text font, a text color, a text size, an audio volume, an audio equalization, a video resolution, a video intensity, a video hue, a device illumination, a device alert, a device vibration, a sound effect, a mechanical effect, or a lighting effect.

3. The method of claim 1, wherein the multimedia message includes network or messaging presence indication.

4. The method of claim 1, further comprising identifying a location and intensity of the sensory action.

5. The method of claim 4, wherein the sensory action is one of a soft, a medium, or a hard physical action for respectively assigning one of a low, medium, or high priority to a threshold of measured intensity.

6. The method of claim 1, further comprising:
measuring a speed of the sensory action;
measuring a pressure of the sensory action; and
assigning a mood rating to the emotional component based on the speed and the pressure, wherein the mood rating adjusts the emotional component.

7. The method of claim 1, further comprising:
measuring a repetition rate of the sensory action;
identifying a rhythm based on the repetition rate; and
assigning a mood rating to the emotional component based on the rhythm, wherein the mood rating adjusts the emotional component.

8. The method of claim 1, wherein the emotional component is an image icon or a sound clip to convey an emotion of a user response.

9. The method of claim 1, wherein the associating a sensory action with said multimedia message, further comprises:
presenting an option associated with the multimedia message; and
selecting the option based on the sensory action.

10. The method of claim 1, further comprising:
conveying emotion during a voice note or recording by adjusting one of a visual or audio aspect.

11. A device for multi-dimensional action capture, comprising:
a media console for creating a multimedia message;
at least one sensory element cooperatively coupled to the media console for capturing a sensory action; and
a processor communicatively coupled to the at least one sensory element and the media console for associating a sensory action with said multimedia message and assigning an emotional component to the multimedia message based on the sensory action.

12. The device of claim 11, wherein the emotional component is one of an avatar, text font, a text color, a text size, an audio volume, an audio equalization, a video resolution, a video intensity, a video hue, a device illumination, a device alert, a device vibration, a sound effect, a mechanical effect, or a lighting effect.

13. The system of claim 11, wherein the processor identifies at least one of a depressing action, a squeezing action, or a sliding action on at least one sensory element.

14. The method of claim 11, wherein the processor identifies a location and intensity of the sensory action.

15. The device of claim 13, further comprising:
an orientation system for determining an orientation of the device such that the emotional component is associated with the orientation.

16. The device of claim 15, further comprising:
a timer for determining a time lapse the device is in a predetermined orientation and signaling an alert based on the time lapse; and
a decision unit connected to the timer and the processor for adjusting an attribute of the multimedia message based on the emotional component.

17. The device of claim 11, further comprising:
a communication unit communicatively connected to the processor for:
receiving the multimedia message; and
decoding the emotional component from the multimedia message.

18. A positional device for sensory monitoring, comprising
at least one sensory element for capturing a sensory action;
a processor communicatively coupled to the at least one sensory element for creating a multimedia message in response to the sensory action;
an orientation system communicatively coupled to the processor for determining an orientation of the positional device; and
a communication unit communicatively connected to the processor for sending the multimedia message,
wherein the decision unit signals an alert in the multimedia message based on the intensity and location of the sensory action or the time lapse.

19. The positional device of claim 18, further comprising:
a timer communicatively coupled to the orientation system for determining a time lapse the device is in the orientation; and
a decision unit connected to the at least one sensory element and the processor for determining whether a user is active by assessing an intensity and location of the sensory action.

20. The positional device of claim 18, wherein the processor identifies a location and intensity of the sensory action.
